(19) United States
(12) Patent Application Publication
(10) Pub. No.: US 2024/0243419 A1
(43) Pub. Date: Jul. 18, 2024

(54) BATTERY CONNECTOR AND BATTERY COVER

(71) Applicants: CPS Technology Holdings LLC, New York, NY (US); Clarios Germany GmbH & Co. KG, Hannover (DE)

(72) Inventors: Jason D. Fuhr, Sussex, WI (US); Arunraj Varatharajah, Menomonee Falls, WI (US); Rengaraj Balakrishnan, Menomonee Falls, WI (US); Tyler Anthony Thiel, Milwaukee, WI (US); Jason David Searl, Bayside, WI (US); Roderique Duell, Hannover (DE); Kathryn Marie Ciurlik, Racine, WI (US); Donald J. Caldwell, Milwaukee, WI (US)

(21) Appl. No.: 18/561,882

(22) PCT Filed: May 20, 2022
(86) PCT No.: PCT/US2022/030389

§ 371 Date: Nov. 17, 2023

Related U.S. Application Data
(60) Provisional application No. 63/191,673, filed on May 21, 2021.

(51) Int. Cl. H01M 50/296; H01M 50/204; H01M 50/271

(52) U.S. Cl. CPC H01M 50/296; H01M 50/204; H01M 50/271; H01M 2220/20

(57) ABSTRACT

Example terminals on a battery cover and example battery covers are described herein. The example terminals provide a more secure connection between a terminal and a connector. Additionally, the example terminals may be shaped such that only specific batteries or battery types can be used with certain vehicles or connectors. The example battery covers may include terminal covers and handles that are integrated into the design of the cover such that a top surface of the cover is planar.

### CROSS-REFERENCE TO RELATED APPLICATIONS

This application claims the benefit of U.S. Provisional Patent Application No. 63/191,673, filed May 21, 2021, entitled “BATTERY CONNECTOR AND BATTERY COVER,” the entire content of which is hereby incorporated herein by reference for all purposes.

### BACKGROUND

The disclosure relates to an electrical power storage device, such as a lead-acid battery or lithium-ion battery, having anti-torque features to secure and prevent rotation of a terminal assembly. Various types of lead-acid and lithium-ion batteries are used in electrical systems, such as an electrical system of, or part of, a vehicle. The batteries may vary in size, shape, battery chemistry, and amp hours. Batteries typically have positive and negative terminals. The example terminals may be posts that are substantially cylindrical and extend above a top surface of a cover of the battery, or out the side of the battery container. In many applications, the terminals are connected to a device or machine (such as a vehicle) using a clamp-style connector.

In some applications, batteries may be provided with a strap or handle to more easily transport the battery to and from a point of installation. This disclosure also relates to an electrical power storage device, such as a lead-acid battery or lithium-ion battery, having a handle or strap. Example straps may be molded of a plastic resin and may extend above the battery. Traditional handles may interfere with, among other areas, the terminal assembly during operation. In many applications, example battery carrying straps may be designed to break and/or tear away following the coupling process, such as, for example securing the battery using a battery hold-down.

This disclosure further relates to an electrical power storage device, such as a lead-acid batter or lithium-ion battery, having terminal covers. Traditional terminal covers are removed and discarded as part of the coupling process to an apparatus (for example, a vehicle).

Another battery alternative is desired to address one or more of the above issues.

### SUMMARY

Example terminals for a battery are described herein. The example terminals include one or more features that provide a more secure connection between a connector and the terminal than the traditional clamp-style connector. The example terminal structure, in one embodiment, comprises a housing having a plurality of cells disposed in an interior of the housing, and a terminal structure including a terminal protrusion coupled to the plurality of cells, the terminal structure further including a feature to securely couple a connector to the terminal structure. In at least one example embodiment, the terminal feature includes a shape of the terminal protrusion. In another example construction, the terminal structure feature can include a groove. The example terminal structure feature can further include a keyed construction.

In another embodiment, a terminal structure for an electrical power storage device is disclosed. The battery comprises a housing having a base and a cover. The housing includes a cover coupled to the base further including a terminal assembly, the terminal assembly having a terminal protrusion including a structure feature. In the example constructions, the terminal protrusions are a male-style terminal. In such example embodiments, the terminals may be shaped to prevent rotation of a connector. For example, the terminal or terminal structure may be substantially square. That is, the terminals may have a substantially square cross-section. In another embodiment, the terminal may have a different shape with a different polygonal cross section. In another embodiment, the terminal may include rounded edges. Additionally, the terminal may taper from a bottom surface to a top surface. In other such constructions, the terminal protrusions may include toothed portions to prevent rotation of a connector. In yet another such embodiment, the terminal may include an annular groove.

In another example embodiment, the example terminal structure comprises a housing having a plurality of cells disposed in an interior of the housing, and a terminal structure including a terminal protrusion coupled to the plurality of cells, the terminal structure further including a feature to securely couple a connector to the terminal structure. In one example construction, a portion of the cover adjacent to the terminal may have a keyed section to secure the connector. In at least one such example, the terminal structure includes a cavity recessed in the cover including a terminal protrusion disposed within the cavity. The terminal cavity can further include a keyed section, which may prevent rotation of the terminal assembly. In another example, they keyed section includes a keyed construction. In at least one embodiment, the keyed construction includes a keyed cavity continuous with the terminal cavity.

Example terminals covers for a battery are also described herein. In one example embodiment, an electrical power storage device comprising a housing having a base portion and a cover is disclosed. The cover includes a surface having an aperture to receive a terminal, and a terminal protrusion fixedly engaged in the aperture and disposed within the cover, the terminal protrusion coupled to six cells disposed within an interior of the housing, each cell separated by a partition. Terminal covers or caps are disposed over the terminal. In another example, the terminal caps include thumb holds. In one such example construction, the terminal caps comprise a cover surface, a first thumb hold surface substantially orthogonal to the cover surface, and a second thumb hold surface substantially orthogonal to the cover surface. In another example, the terminal cap includes a third thumb hold surface substantially orthogonal to the cover surface and coupling the first thumb hold surface to the second thumb hold surface. In other words, the first thumb hold surface may be at an obtuse angle to the third thumb hold surface, and the second thumb hold surface may be at an obtuse angle to the third thumb hold surface.

In one example construction, a terminal structure for an electrical power storage device is disclosed. The battery comprises a housing having a base and a cover. The housing further includes a cover coupled to the base including a terminal assembly, the terminal assembly having a terminal protrusion including a terminal structure feature. In one example the battery cover can include a handle. In some examples, a surface of the handle is aligned with a front surface of the terminal caps when the handle is stowed. In other examples, a surface of the handle is aligned with a top surface of the battery cover when the handle is stowed. That is, the example battery cover comprises terminal caps and a handle, the terminal caps and handle include a respective top surface and a respective side surface having the profile of the side surface of the cover. In at least one example, the profile is arcuate. The example handle may also include a tab for easier lifting of the handle. In yet another example, the handle includes a first arm and a second arm, and a handle disposed between the first arm and the second arm.

In at least another embodiment, an electrical power storage device comprising the housing and cover including the example terminal structure is disclosed, the cover further having terminal caps and a handle. In yet at least another embodiment, a vehicle having the aforementioned is disclosed. The example battery may also include a cover with openings for injecting electrolytic fluid. In some examples, the openings are aligned. In other examples, the openings are staggered on a top surface of the cover. The openings may be capped or plugged.

These and other features, advantages, and embodiments of apparatus and methods according to this invention are described in, or are apparent from, the following detailed descriptions of various examples of embodiments.

### BRIEF DESCRIPTION OF THE DRAWINGS

Various examples of embodiments of the systems, devices, and methods according to this invention will be described in detail, with reference to the following figures.

FIG. 1 is a top perspective view of an example electrical power storage device, such as a battery.

FIG. 2 is a top perspective view of the battery of FIG. 1 with the cover removed.

FIG. 3 is an example environment in which an electrical power storage device described herein may be used.

FIG. 4 depicts a detailed view of an example terminal protrusion to be used with the battery of FIG. 1.

FIG. 5 depicts a detailed view of an example terminal to be used with the battery of FIG. 1 including a keyed portion.

FIG. 6 depicts a detailed view of an example terminal protrusion to be used with the battery of FIG. 1 including a groove.

FIG. 7 is a front perspective view of an example battery having a handle and terminal caps.

FIG. 8 is a top perspective view of the example battery of FIG. 7 including openings on a surface of the cover.

FIG. 9 depicts a front elevation view of the battery of FIGS. 7 and 8 showing a profile perspective of the cover.

FIG. 10 depicts a left side elevation view of the battery of FIGS. 7-9 showing a side profile perspective of the cover.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

Within the scope of this application, it is expressly intended that the various aspects, embodiments, examples, and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### DETAILED DESCRIPTION OF THE DRAWINGS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Referring to the Figures, an electrical power storage device 100 is disclosed, and in particular is a rechargeable battery, such as, for example, a lead-acid battery or a lithium-ion battery. Lithium-ion storage batteries are sealed, while various embodiments of lead-acid storage batteries may be either sealed (e.g., maintenance-free) or unsealed (e.g., wet). According to one or more examples of embodiments, the electrical power storage device 100 is a lithium-ion battery, a sealed lead-acid battery or AGM lead-acid battery. While specific examples are described and illustrated, the battery 100 may be any secondary battery suitable for the purposes provided (i.e., any different battery chemistry).

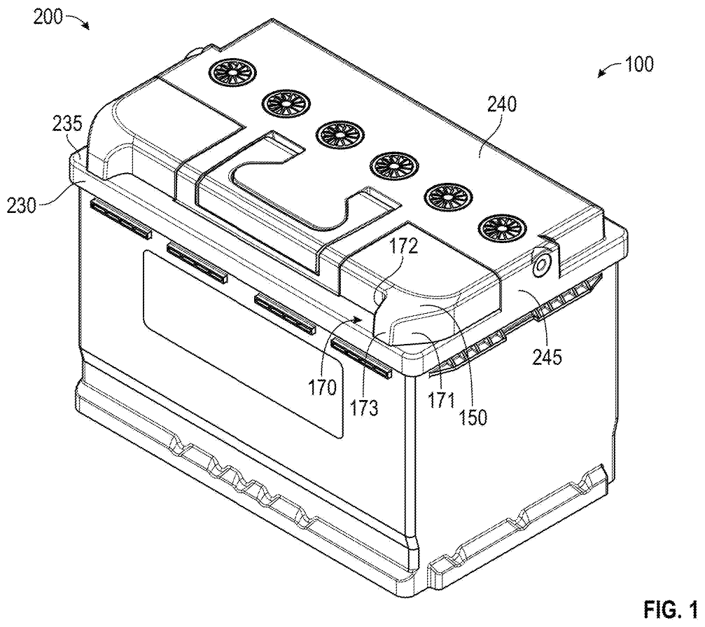

FIG. 1 depicts an example construction of an electrical power storage device or battery 100 having a cover 230 with example terminals 105. The shown battery is a lead-acid battery. The battery can be used in one of a variety of types of vehicles including, among others, automobiles, motorcycles, buses, recreational vehicles, boats, and the like. The electrical power storage device 100 is configured to provide at least a portion of the power to start or operate the vehicle and/or various vehicle systems. Further, it should be understood that the battery 100 may be utilized in a variety of applications not involving a vehicle, and such applications are intended to be within the scope of the disclosure.

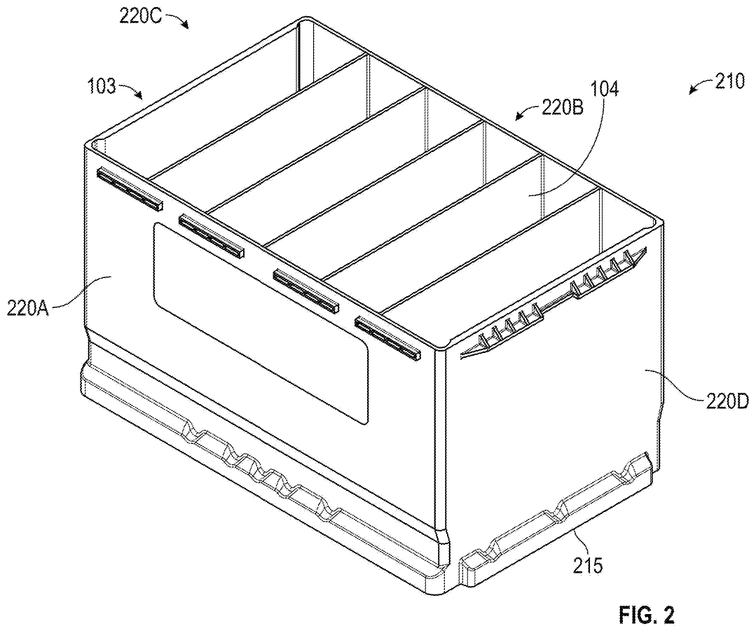

A housing 200 of the battery is shown. The housing includes a box-like container 210 (e.g., a compartment or base portion) having a base wall 215 and can be made at least in part of a moldable resin. In various constructions, including the construction shown in FIGS. 1 and 2, base 210 has a plurality of walls including first and second walls 220A, 220B opposite one another and third and fourth walls 220C, 220D opposite one another. As viewed in the figures, the first and second walls 220A, 220B are front and back walls and the third and fourth walls 220C, 220D are side walls.

An example battery is shown in FIG. 2 with the cover removed. In various constructions, including the construction shown in FIG. 2, the interior of the base or container 210 includes six cell compartments 103A-F, which may be partitioned with five internal partitions 104A-E. In other implementations, the number of cells and/or cell compartments 103 and the number of partitions 104 may vary to support electrical power storage devices with different voltages.

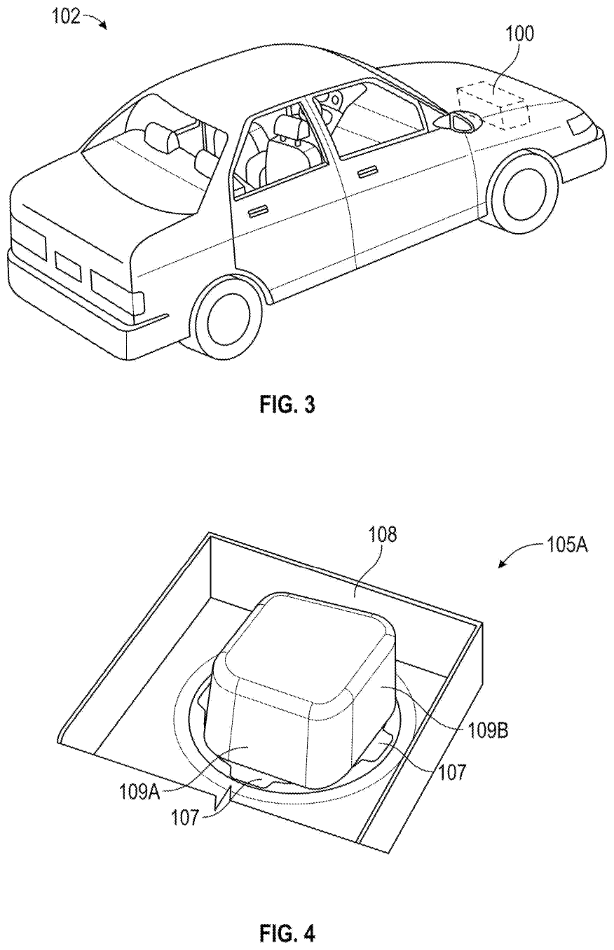

As discussed above, the illustrated example battery 100 may be a lead-acid or lithium-ion battery including a positive terminal and a negative terminal. Alternatively, the battery may be a different type of battery chemistry having a positive terminal and a negative terminal with a similar battery cover or container. The electrical power storage device 100 can be used in one of a variety of types of vehicles including, among others, automobiles, motorcycles, buses, recreational vehicles, boats, and the like. The electrical power storage device 100 is configured to provide at least a portion of the power to start or operate the vehicle and/or various vehicle systems. Further, it should be understood that the electrical power storage device 100 may be utilized in a variety of applications not involving a vehicle, and such applications are intended to be within the scope of the disclosure. A battery 100 is provided and shown in a vehicle 102 in FIG. 3.

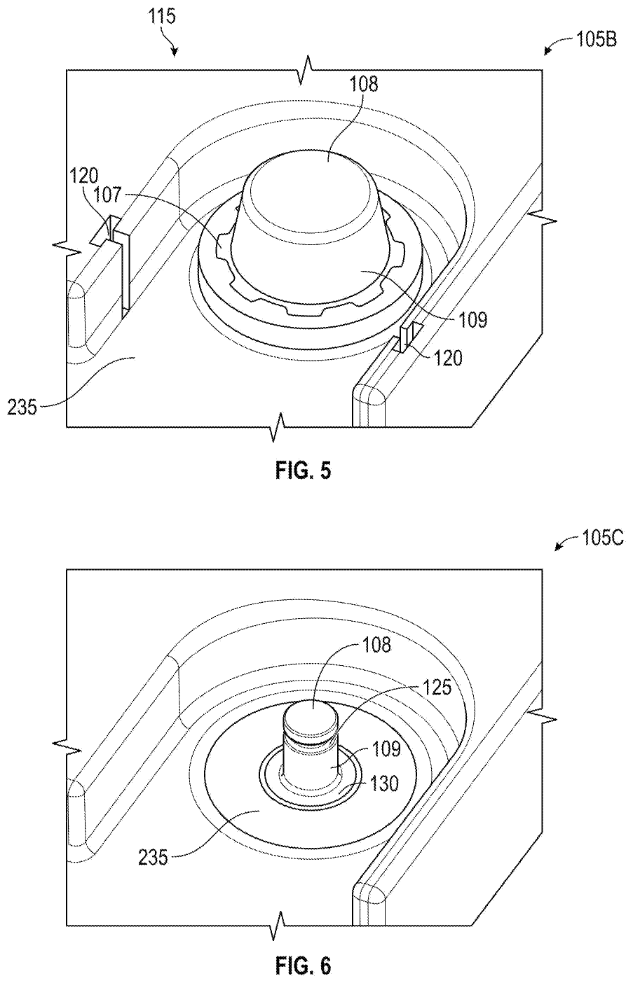

Referring to FIGS. 4-6, terminal protrusions 105A-C are positioned on a portion of the battery cover and disposed in an aperture 130. In the example shown in FIG. 5, the terminal protrusion 105B is provided on a portion of the battery cover 230 that is indented (e.g., on a different plane) relative to a top surface 240 of the battery cover. Alternatively, the terminals may be located on a side of the battery casing or housing 200. The example terminals may be shaped such that only specific batteries or battery types can be used with certain connectors. The indented portion may also have a shape that corresponds to a certain connector or type of connector. The example terminal protrusions 105 are male connectors (e.g., post connectors, studs, prongs, plugs, pins, lugs, etc.), which allow for a fixed or keyed connection that is more secure than a typical clamp-on cylindrical terminal extending above a battery surface. For example, the constructions of the example terminals described herein may decrease or prevent rotation of the connector coupled to the terminal, which reduces wear on the terminal in addition to providing a more secure connection to the terminal.

The example terminal protrusion 105 may be made of a conductive lead-free material, such as aluminum, copper, steel, brass, etc. Using a lead-free material may result in a battery with no exposed lead. A battery without any exposed lead may have benefits (e.g., environmental benefits, health benefits) since there is no potential for lead exposure to the end customer. The example terminal 105 may include one or more annular rings, recesses, protrusions, or shapes to help hold a corresponding connector in place. For example, the corresponding connector may have annular rings that are positioned or spaced on the connector to match up with the annular grooves disposed on the terminal protrusion 105.

FIG. 4 depicts an example terminal. The example terminal 105A is a male connector. The terminal has a substantially square shape with rounded corners. As discussed above, the shape of the example terminal of FIG. 4 prevents rotation of the connector relative to the terminal, which provides a better connection and reduces wear on the terminal and connector. The example terminal includes four sides. The four-sided construction does not allow the edges to easily wear and become too rounded such that there is no longer a defined difference between the surfaces and the connector is able to rotate around the terminal. That is, when an exterior angle between two sides is 90 degrees, the amount of wear needed to allow the connector to rotate is more than when the exterior angle between two sides is 60 degrees (e.g., a hexagonal terminal) or 45 degrees (e.g., an octagonal terminal). Additionally, a toothed area 107 is positioned at a bottom edge of the terminal adjacent to the surface of the indented area. The toothed area 107 also helps secure the connection of the connector to the terminal and prevents rotation of the connector relative to the terminal. In the illustrated example, the toothed area of FIG. 4 includes four teeth, with one tooth placed on each side of the terminal.

In the illustrated example of FIG. 4, the terminal protrusion 105A is positioned on a portion of the battery cover 230 that is flush with a surface of the cover 235. Alternatively, the terminal protrusion 105A may be disposed on a portion of the cover that is indented or projected relative to a surface of the cover. The terminal protrusion 105A includes a feature to securely couple a connector to the terminal structure 110. In the shown example, the terminal protrusion is substantially square having a first surface 108 and multiple surfaces 109A-D substantially orthogonal to the first surface. Side surfaces of the terminal protrusion opposite one another may be substantially parallel. That is, side surface 109A may be parallel to side surface 109C and side surface 109B may be parallel to side surface 109D, as shown in the example construction of FIG. 4. In other example constructions, the terminal 105 may taper from a bottom surface to a top surface. The terminal protrusion 105A may further comprise rounded edges or surfaces coupling the multiple surfaces 109.

FIG. 5 depicts an example terminal 105B that is positioned on an indented portion of the cover. The sides of the indented portion of the cover are keyed, which when used with a corresponding connector having corresponding protrusions, also prevents rotation of the connector relative to the terminal. In the illustrated example, the keys are substantially T-shaped and are on opposite edges of the indented portion or cavity 115. However, other keyed configurations may be used. Additionally, a toothed area 107 is positioned at a bottom edge of the terminal adjacent to the surface of the indented area. The toothed area also helps secure the connection of the connector to the terminal and prevents rotation of the connector relative to the terminal. The illustrated example tooth portion in FIG. 5 includes eight teeth, but another number of teeth may be used.

As described above in connection with FIG. 5, the example terminal 105B is positioned on a portion of the battery cover 230 that is indented relative to the top surface of the battery cover. Additionally, the illustrated top surface is plastic and may be integral with the cover. The indented area may be any suitable shape. In the illustrated examples of FIGS. 5 and 6 the indented portion or terminal cavity 115 is substantially circular. In the example shown, one or more corners may be rounded, alternatively the terminal assembly 110 and terminal cavity 115 may include straight edges. In some examples, the terminal 105 may be off-center on the indented portion. In the illustrated example, a portion 130 of the terminal structure 110 is raised relative to the indented portion of the battery cover 235. In various constructions, including the example construction in FIG. 5, the terminal aperture 130 may be substantially circular and is disposed within the terminal cavity 115. The aperture may project and/or extend from a surface of the cover 235. The terminal aperture 130 may, in alternative constructions, include a cross-section that is substantially rectangular. Alternatively, the terminal aperture 130 of the terminal 105 may be flush with a surface of the cover 235.

The terminal cavity 115 can include a keyed construction, such as, for example a keyed cavity as shown in the example construction of FIG. 5. In at least one example, the keyed cavity 120 includes a shape or key shape. The keyed cavity may also be understood to be a socket or space (i.e., a hole, receiver, hollow, gap, pocket, etc.). In the example embodiment shown, the keyed cavity includes a shape that may permit only certain connectors to be connected to the battery 100. The keyed cavity 120 may additionally prevent rotation of a connector and provide a more stable and secure connection between the terminal protrusion 105 and the connector. In another construction, the keyed cavity 120 is continuous with the terminal cavity 115. That is, the keyed cavity may follow a path or profile matching a path or profile of the terminal cavity. In various constructions, the keyed cavity 120 may follow a vertical path or profile relative to a surface 235 of the battery cover. In other example constructions, the keyed cavity 120 may permit an interlocking effect in operation with a connector. It should be understood that various shapes, paths, profiles and cross-sections of keyed cavities may be contemplated within the scope of the disclosure.

In various examples not shown, the terminal protrusions 105 may include threaded portions. In some examples, the threated portions also includes a keyed section. In other examples, the edges of the indented portions 215 may be keyed to ensure a solid connection of the connector to the terminal. In the illustrated example of FIG. 5, the keys adjacent to the cavity 215 include one or more protrusions from the edges of the indented portion.

As described above, the construction of the terminals 105 depicted in FIGS. 4 and 5 promotes a more secure connection between the terminal and the connector. Referring now to FIG. 6, an example terminal (e.g., a Radsok terminal) having an annular groove positioned adjacent a top edge of the terminal is shown. As with the other example terminals described herein, the example terminal depicted in FIG. 6 also helps secure the connection between the terminal and the connector. For example, the terminal depicted in FIG. 6 may prevent a connection of the connector at an odd or skewed angle. Additionally, as with the other example terminals, the example Radsok terminal 105C is positioned on an indented portion of the cover. In some examples, edges around the indented portion include a ledge or step, which may help align or secure a connector on the example terminal.

The example terminal 105C is substantially cylindrical and extends past a surface 235 of the cover. The terminal protrusion 105C comprises a top surface 108 and body surface 109 including a groove or slot 125 disposed adjacent the top surface of the terminal. In another example embodiment, the terminal 105C may include more than one groove 125. An example electrical power storage device 100 may include a terminal protrusion 105 comprising any one of the aforementioned terminal structure features. The terminal features, in combination with the terminal cavity and keyed construction, may provide a more secure and stable connection between a terminal and a connector.

In another embodiment, an electrical power storage device or battery 100 having a cover 230 with example terminals 105 is disclosed. Referring again to FIG. 1, the example cover 230 also includes first and second terminal caps 150 covering, for example, the terminals described in conjunction with FIGS. 4-6 above. The terminal caps each have a first surface 155 (e.g., a top surface) that forms a portion of the top surface 240 of the battery cover 230. That is, the top surface of each of the terminal caps is on the same plane as the top surface of the rest of the cover. The example terminal caps 150 are removable and include a terminal cover surface or top surface 155, and a side surface 160.

The example terminal caps may include a thumb hold and/or finger hold (e.g., a tab, grip, slot, edge, lip, etc.) 170 adjacent to the bottom of the terminal cap for easier removal. In the construction shown, the terminal cap comprises a cover surface 155 having a thumb hold 170 disposed thereon. The thumb hold 170 can include a first thumb hold surface 171 substantially orthogonal to the cover surface 155, and a second thumb hold surface 172 substantially orthogonal to the cover surface 155. In another embodiment, the terminal cap 150 can include a third thumb hold surface 173 substantially orthogonal to the cover surface 155 and coupling the first thumb hold surface 171 to the second thumb hold surface 172. That is, the first thumb hold surface may be at an obtuse angle to the third thumb hold surface, and the second thumb hold surface may be at an obtuse angle to the third thumb hold surface. The example thumb holds 170 extend from a plane of the front edge of the terminal caps to a plane of the front surface of the battery cover.

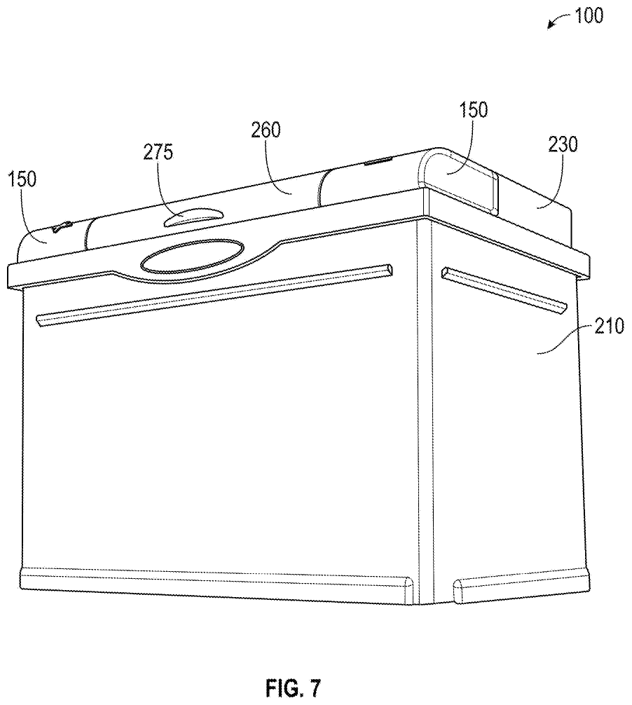

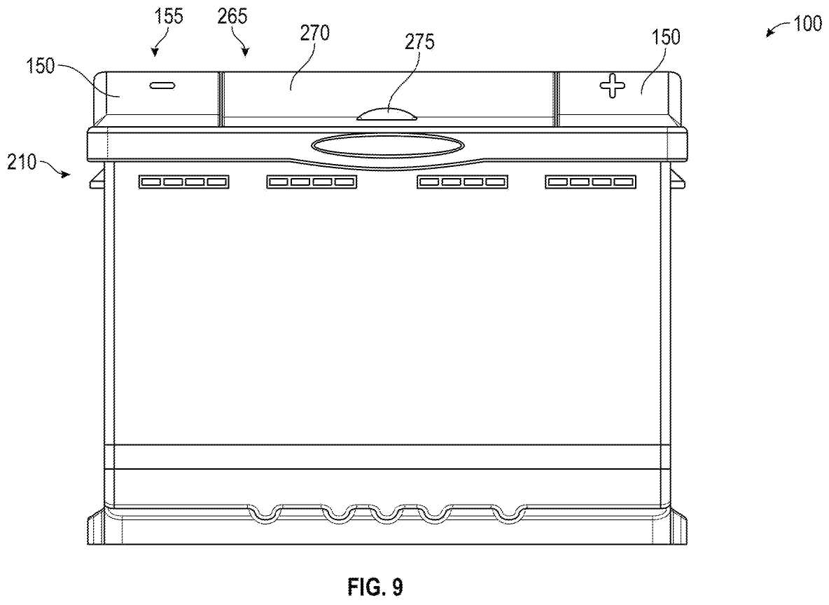

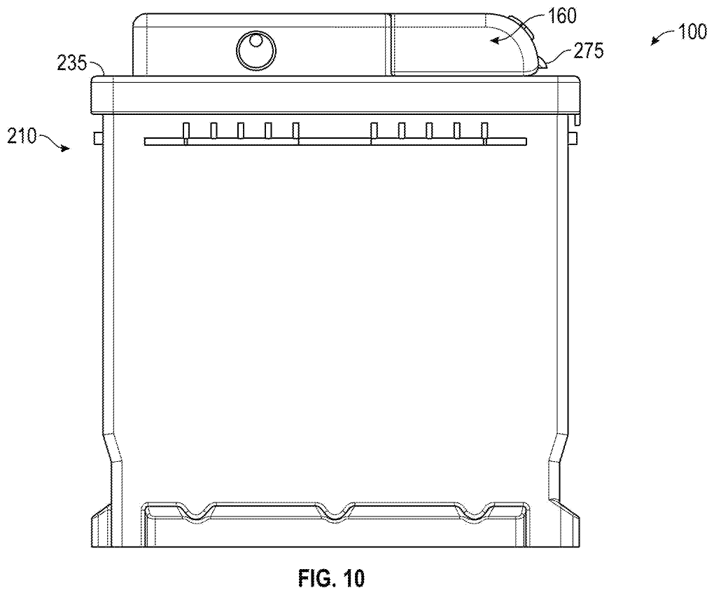

FIGS. 7-10 depict another example construction of electrical power storage device 100 having a cover including terminal caps. In the illustrated example of FIG. 7, the battery 100 additionally comprises a handle positioned across a width of the cover 230, and in some embodiments, extends toward a first surface 220A of the battery. In one embodiment, the handle assembly 250 includes a first arm 255A, a second arm 255B, and a handle 260 coupling the first arm to the second arm. In another embodiment, the handle 260 includes a first surface 265 having the profile of the top surface of the cover 155, and a second surface 270 having the profile of the side surface 160 of the cover 150. The illustrated handle 260 fits within a groove of the cover so that the handle does not extend above a top plane of the cover when the handle is in a stowed position. In another embodiment, the front surface of the handle when in the stowed position is offset from the front surface of the battery cover and has a front edge or surface 270 that is aligned with a front edge of the terminal caps 150. The example handle shown is form-fitting, thus, the battery may be easier to stack, for example, for shipping or shelving purposes, because the top is flat (e.g., a single plane). The illustrated example batteries of FIGS. 7-10 are AGM batteries. In the illustrated examples, a front edge of the handle 270 and terminal caps 160 are rounded. The edge of the rounded portion is slightly offset from the front edge of the cover 230. In the illustrated embodiment, the profile is arcuate. Additionally, the handle 260 includes a protruding feature or tab 275 to enable a user to easily lift the handle.

The example battery cover also includes two opposing side edges along a depth of the battery (e.g., left and right edges) and two opposing side edges along a width of the battery (e.g., front and back edges). When the handle 260 is in the stowed position, a second surface 270 of the handle and front edges of the terminal caps are aligned. The second surface of the handle and front edges of the terminal caps are offset from the front edge of the cover. In the illustrated example, the second surface of the handle and front edges of the terminal caps are slanted, sloped, angled, or tapered toward the front edge of the battery cover. In the illustrated example, the left and right edges of the battery cover include slanted portions that are sloped toward the respective left and right edges of the battery.

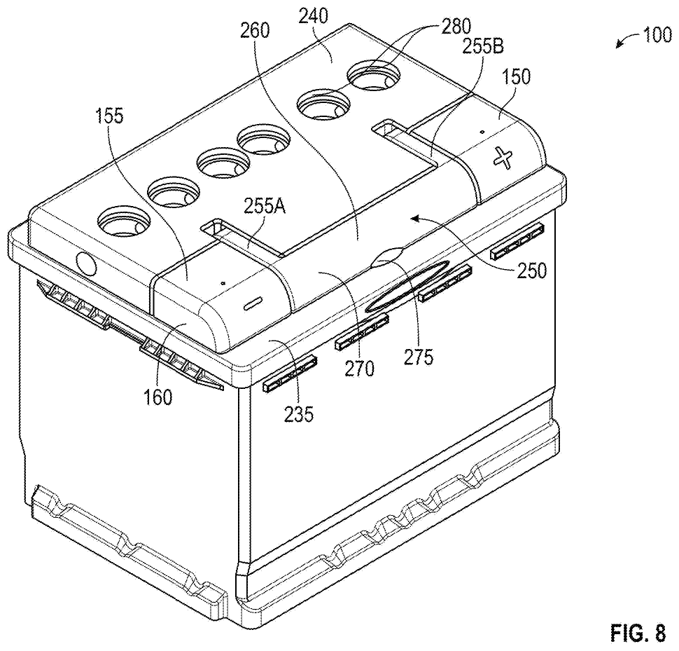

Corners between the left sides and the back edge and the right side and the back edge are rounded. In some examples, the corners are slightly inset from the corners of the battery cover. The terminal caps are positioned on the corners between the left side and the front edge and the right side and the front edge. The corners of the terminal caps may be chamfered or squared instead of rounded. In some examples, edges of the terminals are inset slightly from the plane of the side edges of the battery cover. FIG. 8 depicts an example construction of a cover for a lead-acid battery. The example construction of the cover depicted in FIG. 8 has a first surface (e.g., a top surface) 240. The top surface includes a plurality of openings 280 for inserting or injecting a gel or fluid into the battery. The example openings are covered with caps after the gel or fluid is inserted or injected. In the illustrated example of FIG. 8, the openings are aligned.

The example construction of the battery cover may include one or more vents on the top surface or sides of the cover. The example battery may also include a wired communication port for an electrical system, such as a battery management system (BMS).

One or more of the disclosed embodiments, alone or in combination, may provide one or more technical effects, including easy storage and stacking for shipping and easy removal of terminal caps. The technical effects and technical problems in the specification are exemplary and are not limiting. It should be noted that the embodiments described in the specification may have other technical effects and can solve other technical problems.

Additionally, one or more of the disclosed embodiments, alone or in combination, may provide one or more technical effects including the manufacture of battery covers. The disclosed designs include terminals that enable a more secure connection and/or reduce wear on the terminal caused by rotation of the connector. Accordingly, the disclosed battery module designs may offer improved performance compared to other battery cover and terminal designs. The technical effects and technical problems in the specification are exemplary and are not limiting. It should be noted that the embodiments described in the specification may have other technical effects and can solve other technical problems.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only, and not limiting. Although only a few embodiments have been described in detail in this disclosure, those skilled in the art who review this disclosure will readily appreciate that many various alternatives, modifications, variations, improvements and/or substantial equivalents, whether known or that are or may be presently foreseen, are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A battery comprising:
a housing;
a plurality of cells disposed in the housing; and
a terminal structure comprising:
a terminal protrusion coupled to the plurality of cells and supported by the housing, the terminal structure including a first surface and multiple surfaces substantially orthogonal to the first surface; and
a feature to securely couple a connector to the terminal structure.

2. The battery of claim 1, wherein the feature includes a shape of the terminal protrusion.

3. The battery of claim 1, wherein the feature includes a groove.

4. The battery of claim 1, wherein the feature includes a keyed construction.

5. The battery of claim 1, wherein the feature includes the multiple surfaces.

6. The battery of claim 5, wherein the multiple surfaces include a second surface, a third surface substantially parallel to the second surface, a fourth surface, and a fifth surface substantially parallel to the fourth surface.

7. The battery of claim 5, wherein the terminal protrusion includes a rounded surface coupling the multiple surfaces.

8. The battery of claim 1, wherein the terminal structure further includes a cavity, wherein the terminal protrusion is disposed within the cavity, wherein the cavity further includes a keyed construction, and wherein the feature includes the keyed construction.

9. The battery of claim 8, wherein the keyed construction includes a keyed cavity continuous with the cavity.

10-19. (canceled)

20. A battery comprising:
a housing having a base and a cover;
a plurality of cells disposed in the housing;
a terminal protrusion coupled to the plurality of cells and supported by the housing; and
wherein the cover comprises a moveable terminal cap covering the terminal protrusion, the terminal cap including:
a cover surface;
a first thumb hold surface substantially orthogonal to the cover surface; and
a second thumb hold surface substantially orthogonal to the cover surface, the first thumb hold surface and the second thumb hold surface to facilitate movement of the terminal cap.

21. The battery of claim 20, wherein the terminal cap is removable.

22. (canceled)

23. The battery of claim 20, wherein the terminal cap includes a third thumb hold surface substantially orthogonal to the cover surface and coupling the first thumb hold surface to the second thumb hold surface.

24. The battery of claim 23, wherein the first thumb hold surface is at an obtuse angle to the third thumb hold surface, and the second thumb hold surface is at an obtuse angle to the third thumb hold surface.

25. A battery comprising:
a housing having a base and a cover, the cover comprising:
a first top surface and a first side surface;
a terminal cap, the terminal cap having a second top surface and a second side surface, the respective first top and second top surface and the respective first and second side surface define a first profile; and
a handle structure having a first arm, a second arm, and a handle coupling the first arm to the second arm, the handle including a surface defining a second profile, the first profile and the second profile being congruent.

26. The battery of claim 25, wherein the handle includes a tab to more readily move the handle when the handle is stowed.

27. The battery of claim 25, wherein a second surface of the handle is aligned with a top surface of the cover when the handle is stowed.

28. (canceled)

29. The battery of claim 25, wherein the first profile and the second profile are an arcuate surface.
